(19) United States
(12) Patent Application Publication
(10) Pub. No.: US 2006/0026037 A1
(43) Pub. Date: Feb. 2, 2006

(54) Online doctor/patient lead system and associated methods

(75) Inventor: Glen Lubbert, Winter Park, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: LocateADoc, LLC, Winter Park, FL (US)

(21) Appl. No.: 11/139,823

(22) Filed: May 27, 2005

Related U.S. Application Data
(60) Provisional application No. 60/591,744, filed on Jul. 28, 2004.

(51) Int. Cl. G06Q 10/00

(52) U.S. Cl. 705/2; 705/35

(57) ABSTRACT

A computer implemented online patient lead system includes a medical service provider database storing information for medical services offered by medical service providers, and a patient interface module cooperating with the medical service provider database for prompting and receiving patient input data over the Internet relating to a selected medical service offered by at least one selected medical service provider. The patient lead system may further include a financing module cooperating with the patient interface module and the medical service provider database for determining patient financing approval for the selected medical service, and notifying the at least one selected medical service provider of patient financing approval to thereby serve as a patient lead.

### RELATED APPLICATION

This application is based upon prior filed copending provisional application Ser. No. 60/591,744 filed Jul. 28, 2004, the entire subject otter of which is incorporated herein by reference in its entirety.

### FIELD OF THE INVENTION

The invention relates to the field of medical services, and, more particularly, to the promotion of medical services and related methods.

### BACKGROUND OF THE INVENTION

There are a number of medical service systems that offer various medical services over the Internet or some other communication network. Such systems are used to facilitate the sale of medical services by bringing together prospective patients, medical services providers, and medical service financial providers. For example, U.S. Published application No. 2002/0116220 to Glazier discloses an online system for the selecting, scheduling, and financing of medical procedures. The system can also display to the prospective patient a list of potential surgeons. Similarly, U.S. Published application No. 2004/0172291 to Knowlton discloses a system for processing medical services contracts and electronically recommending patients to surgeons. The system also provides for office staff to contact a prospective patient to discuss financial services options for offered medical services.

Other medical service systems provide for the funding of a medical service for a prospective patient. For instance, U.S. Published application No. 2003/0149594 to Beazley et al. discloses a system for real-time pre-adjudication, pre-funding, and payment of medical expenses to a medical service provider via a communications network. U.S. Published application No. 2003/0050795 to Baldwin, Jr. et al. discloses a system for computing fees associated with health care services, obtaining credit information for the patient, and issuing a health care consumer debt note for the patient for at least a portion of the computed costs of the medical service based upon the obtained credit information. U.S. Pat. No. 6,735,569 to Wizig discloses a system for permitting a user to select medical services and payment methods over the Internet. The system generates a list of suitable medical service providers based upon the selected medical services and payment method. U.S. Published application No. 2002/0010594 to Levine discloses a system for issuing a healthcare credit card to pay for medical services and the medical services provider can be selected from a website.

Other medical service systems provide for the referral of patients to medical service providers. U.S. Published application No. 2003/0187691 to Dutt et al., for example, discloses a referral system in which a knowledgeable host analyzes a prospective patient's inquiry submitted to the system. The knowledgeable host generates a list of appropriate medical service providers based upon the inquiry for the prospective patient.

Unfortunately, the above systems may not effectively and efficiently bring together prospective patients, medical service providers, and medical service financial providers.

### SUMMARY OF THE INVENTION

In view of the foregoing background, it is therefore an object of the invention to provide a system that effectively and efficiently brings together prospective patients, medical service providers, and medical service financial providers.

This and other objects, features, and advantages in accordance with the invention are provided by a computer implemented online patient lead system where medical service providers are advised based upon patient financial qualification. The system may include a medical service provider database storing information for medical services offered by medical service providers, and a patient interface module cooperating with the medical service provider database for prompting and receiving patient input data over the Internet relating to a selected medical service offered by at least one selected medical service provider. The system may further include a financing module cooperating with the patient interface module and the medical service provider database for determining patient financing approval for the selected medical service, and notifying the at least one selected medical service provider of patient financing approval to thereby serve as a patient lead. Accordingly, a system is provided that effectively and efficiently brings together prospective patients, medical service providers, and medical service financial providers.

The patient lead system may include the patient interface module prompting and receiving patient identity data. Accordingly, the financing module may communicate with a credit clearinghouse to determine patient financing approval based upon the patient identity data. Alternately or additionally, the patient interface module may prompt and receive patient financial data, and the financing module may determine patient financing approval based upon the patient financial data.

The patient interface module may prompt and receive data from a patient so that the patient may select a payment plan from among a plurality of offered payment plans. The system may further include a search module cooperating with the medical service provider database and the patient interface module to permit patient searching of offered medical services and medical service providers. The search module may permit searching of medical service providers by geographic area, for example.

The system may also include a patient report module cooperating with the search module for sending the patient data related to at least one of offered medical services and medical service providers. The system may further include a medical service provider interface module for prompting and receiving medical service provider input data over the Internet for updating the medical service provider database.

The system of the present invention has particular applicability to offered medical services that include elective medical procedures, such as certain types of cosmetic surgery. This is so because such procedures are typically not covered by insurance plans and are paid for directly by patients. Accordingly, the medical service provider would typically be more interested in patient leads for prospective patients that have already been financially approved.

Another aspect of the invention is directed to a computer implemented online method for patient lead generation. The method may include storing information for medical services offered by medical service providers, and prompting and receiving patient input data over the Internet relating to a selected medical service offered by at least one selected medical service provider. The method may further include using a financial module to determine patient financing approval for the selected medical service, and notify the at least one selected medical service provider of patient financing approval to thereby serve as a patient lead. Yet another aspect of the invention is directed to a processor readable storage medium containing processor readable code for programming a processor to perform the method for patient lead generation.

### BRIEF DESCRIPTION OF THE DRAWINGS

FIG. 1 is a schematic block diagram of the computer implemented online patient lead system in accordance with the invention.

FIG. 2 is a computer screen illustrating payment plans used in the system shown in FIG. 1.

FIG. 3 is a computer screen illustrating prospective patient input prompts and patient input data used in the system shown in FIG. 1.

FIG. 4 is a computer screen illustrating notification of prospective patient financing approval used in the system shown in FIG. 1.

FIG. 5 is a computer screen illustrating a medical service provider match used in the system shown in FIG. 1.

FIG. 6 is a computer screen illustrating a patient search for a medical service provider used in the system shown in FIG. 1.

FIG. 7 is a computer screen illustrating a lead update alert used in the system shown in FIG. 1.

FIG. 8 is a computer screen illustrating enrollment information sent to unenrolled medical service providers used in the system shown in FIG. 1.

FIG. 9 is a flowchart illustrating method aspects according to the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

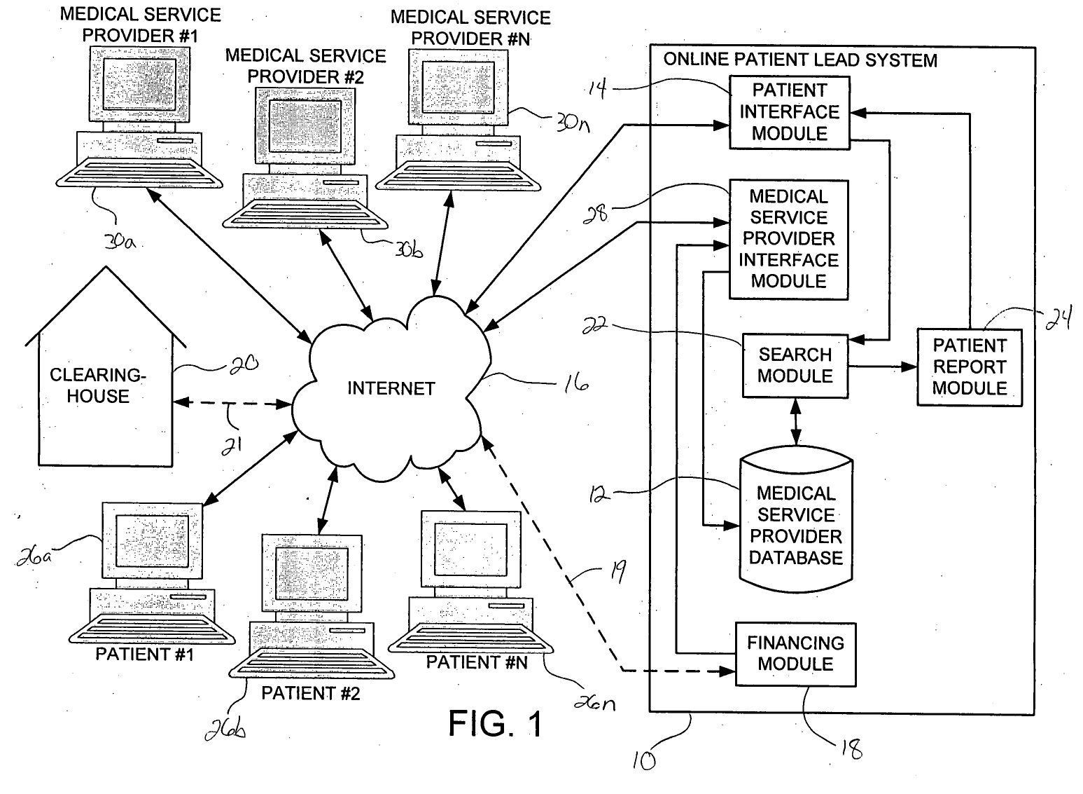

Referring initially to FIG. 1, the computer implemented online patient lead system 10 is now initially described. The system 10 illustratively includes a medical service provider database 12 storing information for medical services offered by medical service providers, and a patient interface module 14 cooperating with the medical service provider database for prompting and receiving patient input data over the Internet 16 relating to a selected medical service offered by at least one selected medical service provider.

One or more prospective patients may connect to the patient interface module 14 via respective computers 26a-26n over Internet 16 as will be appreciated by those skilled in the art. The offered medical services may include elective medical procedures such as cosmetic surgery, hair restoration, cosmetic dentistry, and the like. Such medical services are typically not covered by various health insurance plans; hence, it may be especially helpful for medical service providers to know in advance whether a patient is financially qualified for such a procedure.

The system 10 further includes a financing module 18 cooperating with the patient interface module 14 and the medical service provider database 12 for determining patient financing approval for the selected medical service, and notifying the at least one selected medical service provider of patient financing approval to thereby serve as a patient lead, for example. As will be readily appreciated by those skilled in the art, the patient interface module 14 prompts and receives patient identity data used by the financing module 18. The patient interface module 14 may also prompt and receive patient financial data used internally by the financing module 18 to determine patient financing approval based upon the patient financial data. Alternately, as indicated by the dashed communication lines 19 and 21, the patient interface module 14 may communicate with a credit clearinghouse 20 to determine patient financing approval based upon the patient identity data as will be appreciated by those skilled in the art.

The system 10 illustratively includes the patient interface module 14 prompting and receiving a selected payment plan from the patient from among a plurality of offered payment plans. The system 10 may further include a search module 22 cooperating with the medical service provider database 12 and the patient interface module 14 to permit patient searching of offered medical services and medical service providers as will be appreciated by those skilled in the art. For example, the search module 22 may permit searching of medical service providers by geographic area.

The system 10 also illustratively includes a patient report module 24 cooperating with the search module 22 for sending a patient data related to the offered medical services and/or medical service providers, for example. Cost information could also be included with the data.

The system 10 further includes a medical service provider interface module 28 for prompting and receiving medical service provider input data over the Internet 16 for updating the medical service provider database 12, for example. One or more medical service providers may connect to the medical service provider interface module 28 via respective computers 30a-30n over Internet 16 as will be appreciated by those skilled in the art.

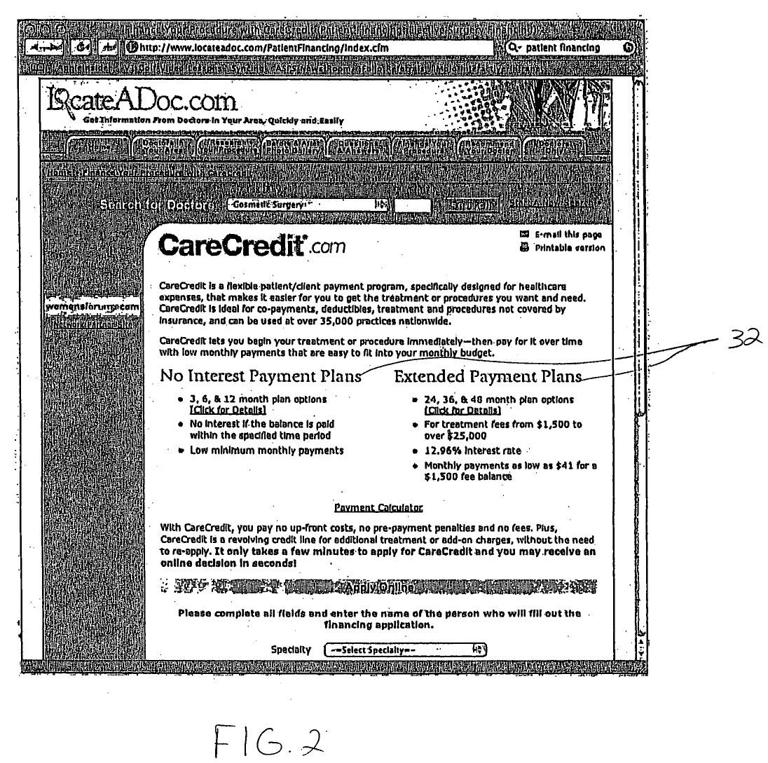

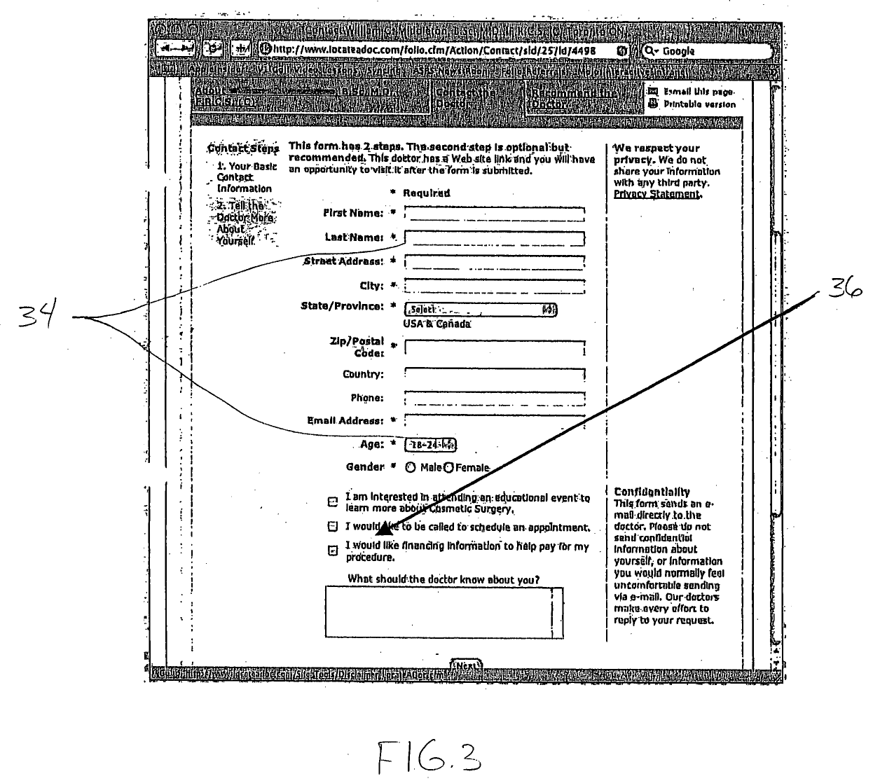

An example of how a prospective patient may use system 10 is now described. Referring now to the exemplary computer screens of FIGS. 2 and 3, a prospective patient learns about possible financing plans 32 and begins the application process by filling in a number of informational fields 34 in the form. If a prospective patient checks contact box 36, they will be directed to a financing application, for example.

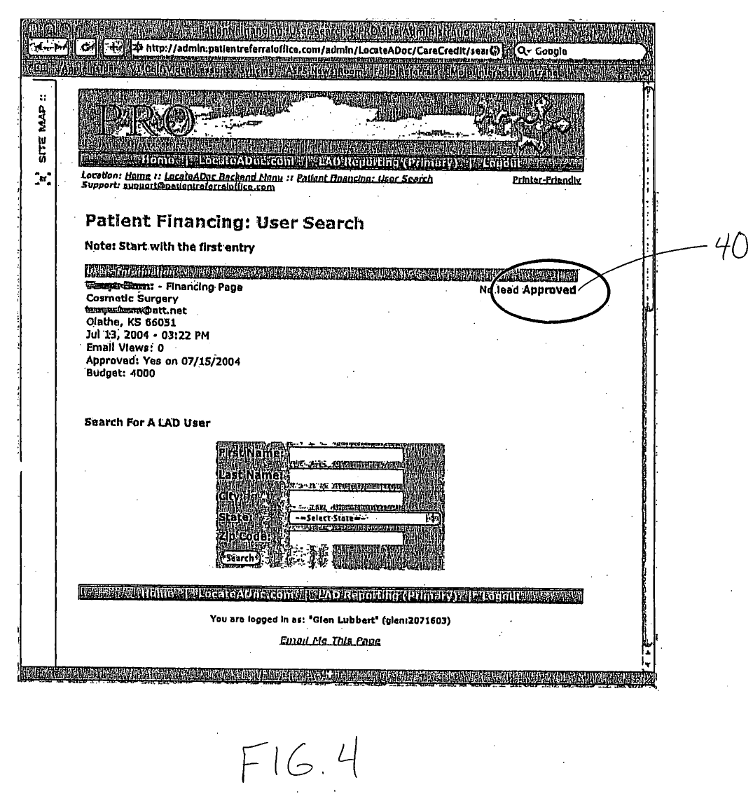

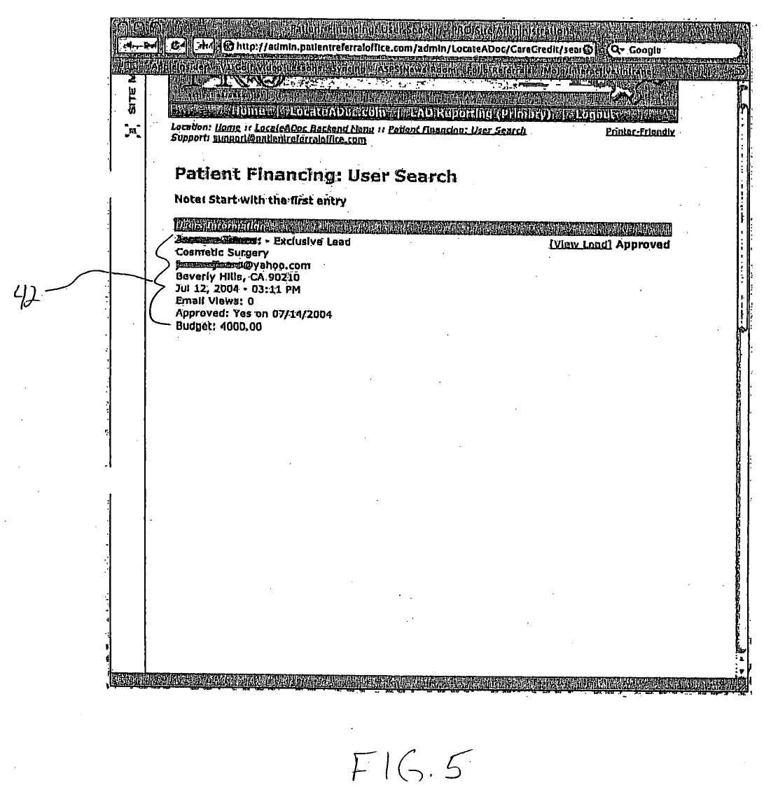

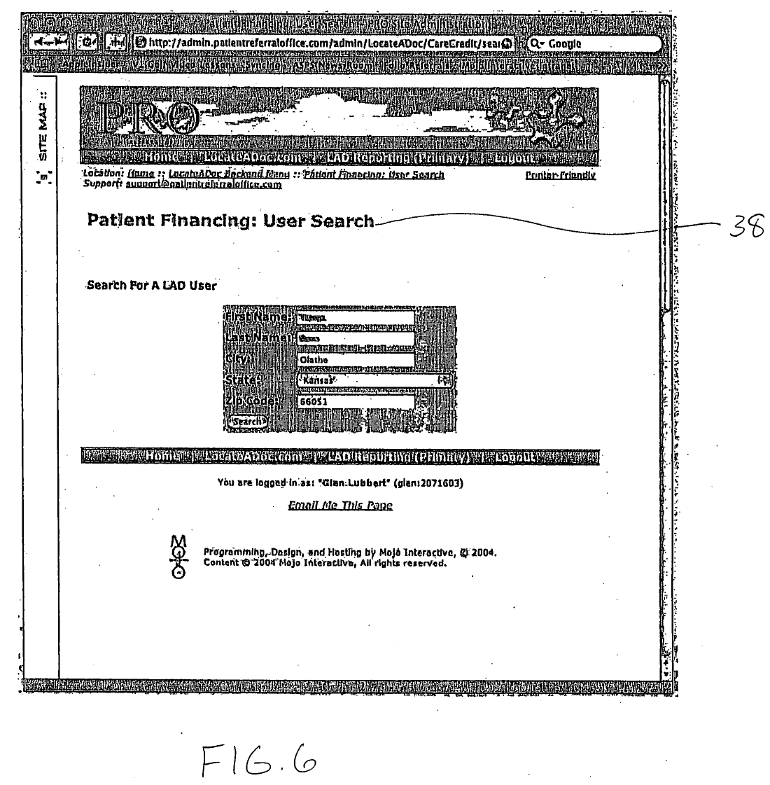

Referring now to additionally to the computer screens of FIGS. 4-6, the financing application is used by the financing module 18 to determine whether the prospective patient is approved for financing for the selected medical procedure. The financing approval is noted by approval notice 40. The system 10 then matches the approved patient to at least one medical service provider in the medical service provider database 12 as shown by medical service provider match 42. Alternately, the prospective patient can search the medical service provider database 12 using search module 22 to execute a user search 38 to locate a medical service provider.

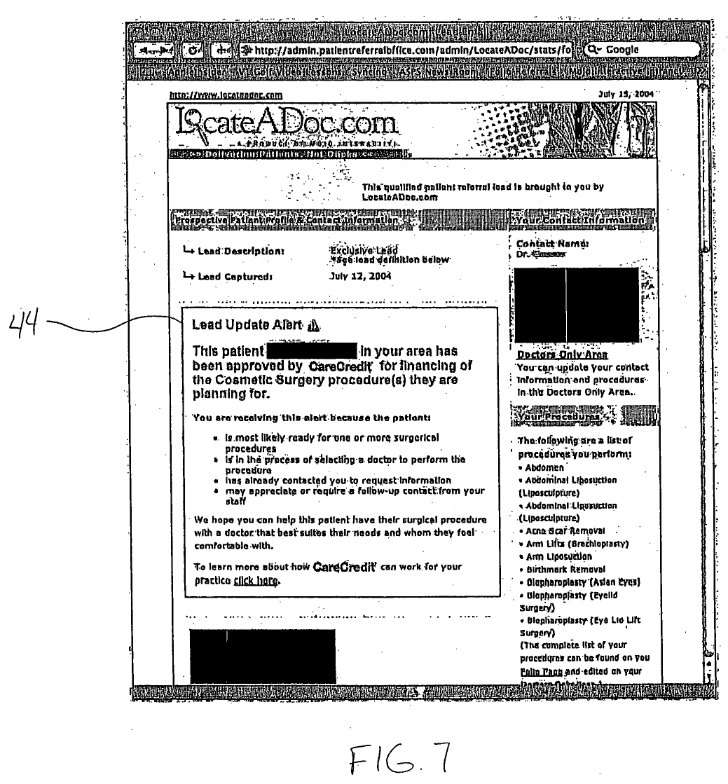

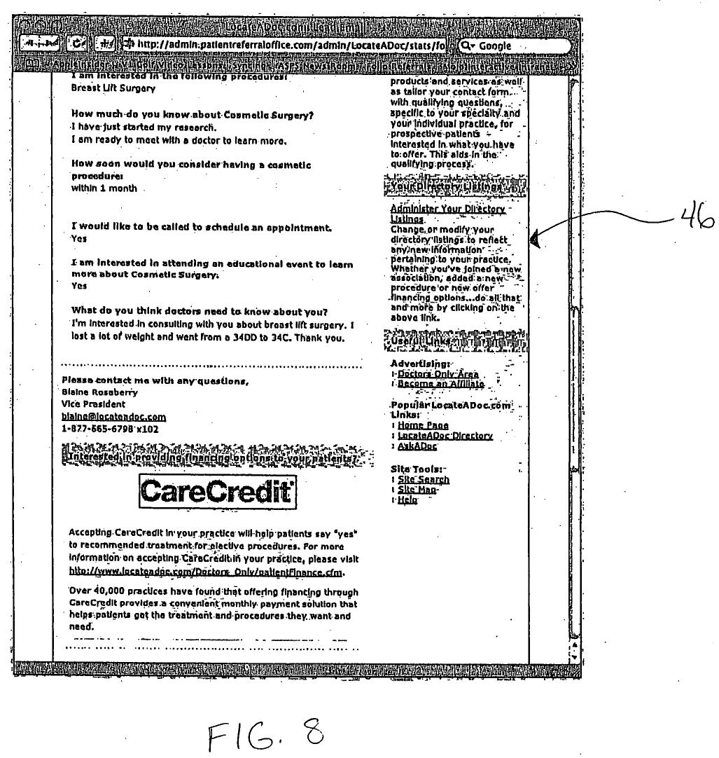

In both cases, and referring now to the computer screens of FIGS. 7 and 8, if the prospective patient had previously selected a medical service provider and checked contact box 36, the system 10 will notify the selected medical service provider that the prospective patient is interested in having them perform a particular medical service by sending a lead update alert 44. The lead update alert 44 may be sent by email to the selected medical service provider. Alternately, the lead update alert 44 may be sent by fax, voicemail, and the like. Additionally, if a selected medical service provider is not enrolled in the system 10, the system will send enrollment information 46 with the lead update alert 44.

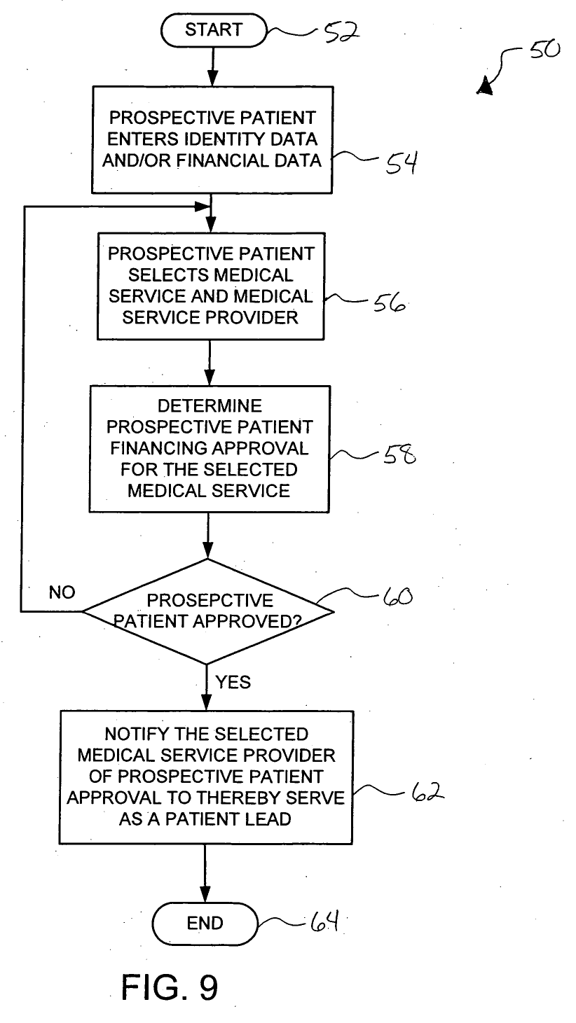

Another aspect of the invention is directed to a computer implemented online method for patient lead generation, which is now described with reference to flowchart 50 of FIG. 9. The method begins at Block 52 and may include the prospective patient entering identity data and/or financial data at Block 54. The method may further include storing information for medical services offered by medical service providers, and prompting and receiving patient input data over the Internet relating to a selected medical service offered by at least one selected medical service provider at Block 56.

The method may also include using the financial module, as described herein, to determine patient financing approval for the selected medical service at Block 58. If the prospective patient is not approved at Block 60, the prospective patient is permitted to reselect a medical service and/or medical service provider. If the prospective patient is approved at Block 60, the system will notify the at least one selected medical service provider of patient financing approval to thereby serve as a patient lead at Block 62, and the method ends at Block 64. Yet another aspect of the invention is directed to a processor readable storage medium containing processor readable code for programming a processor to perform the previously described method for patient lead generation.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A computer implemented online patient lead system comprising:
a medical service provider database storing information for medical services offered by medical service providers;
a patient interface module cooperating with said medical service provider database for prompting and receiving patient input data over the Internet relating to a selected medical service offered by at least one selected medical service provider; and
a financing module cooperating with said patient interface module and said medical service provider database for
determining patient financing approval for the selected medical service, and
notifying the at least one selected medical service provider of patient financing approval to thereby serve as a patient lead.

2. The computer implemented online patient lead system according to claim 1 herein said patient interface module prompts and receives patient identity data; and wherein said financing module communicates with a credit clearinghouse and determines patient financing approval based upon the patient identity data.

3. The computer implemented online patient lead system according to claim 1 wherein said patient interface module prompts and receives patient financial data; and wherein said financing module determines patient financing approval based upon the patient financial data.

4. The computer implemented online patient lead system according to claim 1 wherein said patient interface module prompts and receives a selected payment plan from the patient from among a plurality of offered payment plans.

5. The computer implemented online patient lead system according to claim 1 further comprising a search module cooperating with said medical service provider database and said patient interface module for permitting patient searching of at least one of offered medical services and medical service providers.

6. The computer implemented online patient lead system according to claim 5 wherein said search module permits searching of medical service providers by geographic area.

7. The computer implemented online patient lead system according to claim 5 further comprising a patient report module cooperating with said search module for sending a patient data related to at least one of offered medical services and medical service providers.

8. The computer implemented online patient lead system according to claim 1 further comprising a medical service provider interface module for prompting and receiving medical service provider input data over the Internet for updating said medical service provider database.

9. The computer implemented online patient lead system according to claim 1 wherein the offered medical services comprise elective medical procedures.

10. A computer implemented online patient lead system comprising:
a medical service provider database storing information for medical services offered by medical service providers, the offered medical services comprising elective medical procedures;
a patient interface module cooperating with said medical service provider database for prompting and receiving patient input data over the Internet relating to a selected medical service offered by at least one selected medical service provider;
a search module cooperating with said medical service provider database and said patient interface module for permitting patient searching of at least one of offered medical services and medical service providers by geographic area; and
a financing module cooperating with said patient interface module and said medical service provider database for
determining patient financing approval for the selected medical service, and
notifying the at least one selected medical service provider of patient financing approval to thereby serve as a patient lead.

11. The computer implemented online patient lead system according to claim 10 wherein said patient interface module prompts and receives patient identity data; and wherein said financing module communicates with a credit clearinghouse and determines patient financing approval based upon the patient identity data.

12. The computer implemented online patient lead system according to claim 10 wherein said patient interface module prompts and receives patient financial data; and wherein said financing module determines patient financing approval based upon the patient financial data.

13. The computer implemented online patient lead system according to claim 10 wherein said patient interface module prompts and receives a selected payment plan from the patient from among a plurality of offered payment plans.

14. The computer implemented online patient lead system according to claim 10 further comprising a patient report module cooperating with said search module for sending a patient data related to at least one of offered medical services and medical service providers.

15. The computer implemented online patient lead system according to claim 10 further comprising a medical service provider interface module for prompting and receiving medical service provider input data over the Internet for updating said medical service provider database.

16. A computer implemented online method for patient lead generation comprising:
storing information for medical services offered by medical service providers;
prompting and receiving patient input data over the Internet relating to a selected medical service offered by at least one selected medical service provider; and
using a financial module to determine patient financing approval for the selected medical service, and to notify the at least one selected medical service provider of patient financing approval to thereby serve as a patient lead.

17. The computer implemented online method according to claim 16 further comprising:
prompting and receiving patient identity data; and
using the financial module to communicate with a credit clearinghouse to determine patient financing approval based upon the patient identity data.

18. The computer implemented online method according to claim 16 further comprising:
prompting and receiving patient financial data; and
using the financial module to determine patient financing approval based upon the patient financial data.

19. The computer implemented online method according to claim 16 further comprising prompting and receiving a selected payment plan from the patient from among a plurality of offered payment plans.

20. The computer implemented online method according to claim 16 further comprising permitting patient searching of at least one of offered medical services and medical service providers.

21. The computer implemented online method according to claim 20 further comprising sending to the patient data related to at least one of offered medical services and medical service providers.

22. The computer implemented online method according to claim 16 further comprising prompting and receiving medical service provider input data over the Internet for updating the medical service provider database.

23. The computer implemented online method according to claim 10 wherein the offered medical services comprise elective medical procedures.

24. A processor readable storage medium containing processor readable code for programming a processor to perform a method for patient lead generation comprising:
storing information for medical services offered by medical service providers;
prompting and receiving patient input data over the Internet relating to a selected medical service offered by at least one selected medical service provider; and
using a financial module to determine patient financing approval for the selected medical service, and to notify the at least one selected medical service provider of patient financing approval to thereby serve as a patient lead.

25. The processor readable storage medium according to claim 24 further comprising:
prompting and receiving patient identity data; and
using the financial module to communicate with a credit clearinghouse to determine patient financing approval based upon the patient identity data.

26. The processor readable storage medium according to claim 24 further comprising:
prompting and receiving patient financial data; and
using the financial module to determine patient financing approval based upon the patient financial data.

27. The processor readable storage medium according to claim 24 further comprising prompting and receiving a selected payment plan from the patient from among a plurality of offered payment plans.

28. The processor readable storage medium according to claim 24 further comprising permitting patient searching of at least one of offered medical services and medical service providers.

29. The processor readable storage medium according to claim 28 further comprising sending to the patient data related to at least one of offered medical services and medical service providers.

30. The processor readable storage medium according to claim 24 further comprising prompting and receiving medical service provider input data over the Internet for updating the medical service provider database.

31. The processor readable storage medium according to claim 24 wherein the offered medical services comprise elective medical procedures.
